(19) United States
(12) Patent Application Publication
(10) Pub. No.: US 2018/0084740 A1
(43) Pub. Date: Mar. 29, 2018

(54) PLANT SAFETY DEVICE

(71) Applicant: KEVIN SCHIMMOELLER, OTTOVILLE, OH (US)

(72) Inventor: KEVIN SCHIMMOELLER, OTTOVILLE, OH (US)

(21) Appl. No.: 15/273,717

(22) Filed: Sep. 23, 2016

(51) Int. Cl. A01G 13/10

(52) U.S. Cl. CPC A01G 13/10

(57) ABSTRACT

The present invention relates to a plant safety device preventing other plants and animals from encroaching into the space reserved for the plant to be protected and thereby helping the plant to grow well.

### FIELD OF THE INVENTION

The present invention relates to a plant safety device which prevents other plants and animals from encroaching into the space reserved for the plant to be protected and thereby helping the plant to grow well within a specified condition.

### BACKGROUND OF THE INVENTION

Planting trees and plants are directly related to healthy and wealthy environmental conditions and a healthy environment is directly related to healthy human beings. The problem herein, is not about planting trees but is about protecting small trees and plants because the small trees and plants are unable to protect themselves properly from the external environment and therefore, suffer from harsh environmental conditions and animal behavior. Trees absorb odors and pollutant gases like (nitrogen oxides, ammonia, sulfur dioxide and ozone) and filter particulates out of the air by trapping them on their leaves and bark. They also provide food and beauty for humans to enjoy. But the plants that are exposed without any protective covering may be eaten by fauna, such as squirrels, birds and rabbits.

Also, deforestation is an arising main environmental and social issue these days. Deforestation is arising as the major global problem to society and the environment. The regular cutting of the forests creates negative effects over the climate, environment and biodiversity. Therefore, there is need to protecting trees and plants to save the environment for our future.

For the above mentioned reasons, the present invention provides the plant safety device which eliminates all the above mentioned problems.

### SUMMARY OF THE INVENTION

The main objective of the present invention is to overcome the limitations of the prior arts by providing a plant safety device which eliminates other plants and animals from encroaching into the space reserved for the plant to be protected and thereby helping the plant to grow well within a specified environmental condition.

The plant safety device herein comprises: plurality of flexible structures coupled with plurality of clamping units, wherein the plurality of clapping units are designed to configure the plurality of flexible structures either horizontally or vertically around the circumference of the plant to be protected. The at least one user willing to prevent the plants from encroaching into the space reserved for the plant to be protected and thereby helping the plant to grow well within a specified condition is provided with the plant safety device, wherein the plant safety device comprises plurality of flexible structures coupled with plurality of clamping units, wherein the plurality of clamping units are formed with two open ends, curled over one another and the plurality of clamping units are further designed to clip around the plurality of flexible structures in order to configure the plurality of flexible structures in whichever form desired to cover the plant. Herein, the at least one user is enabled to fix the plant safety device around any plant he/her is willing to protect by applying some force over the plurality of flexible structures which are enabled to be bent according to any desired shape and size and further hold the plurality of flexible structures in the desired shape and size around the plant or against the ground with the help of the plurality of clamping means.

### BRIEF DESCRIPTION OF THE DRAWINGS

For a more complete understanding of embodiment(s), reference now is made to the following descriptions taken in connection with the accompanying drawings. The use of the same symbols in different drawings typically indicates similar or identical items, unless context dictates otherwise. The illustrative embodiments described in the detailed description, drawings, and claims are not meant to be limiting. Other embodiments may be utilized, and other changes may be made, without departing from the spirit or scope of the subject matter presented here.

FIG. 1 illustrates the perspective view of the given invention according to an embodiment of the invention.

### DETAIL DESCRIPTION OF DRAWINGS

For the purposes of promoting an understanding of the principles of the invention, reference will now be made to the embodiments illustrated in the drawings and specific language will be used to describe the same. It will nevertheless be understood that no limitation of the scope of the invention is thereby intended, such alterations and further modifications in the illustrated device, and such further applications of the principles of the invention as illustrated therein being contemplated as would normally occur to one skilled in the art to which the invention relates.

References to “one embodiment,” “at least one embodiment(s),” “an embodiment,” “one example,” “an example,” “for example,” and so on indicate that the embodiment(s) or example(s) may include a particular feature, structure, characteristic, property, element, or limitation but that not every embodiment or example necessarily includes that particular feature, structure, characteristic, property, element, or limitation. Further, repeated use of the phrase “in an embodiment” does not necessarily refer to the same embodiment.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, the preferred methods and materials are now described. All publications, patents and patent computer implemented methods mentioned herein are incorporated herein in their entirety.

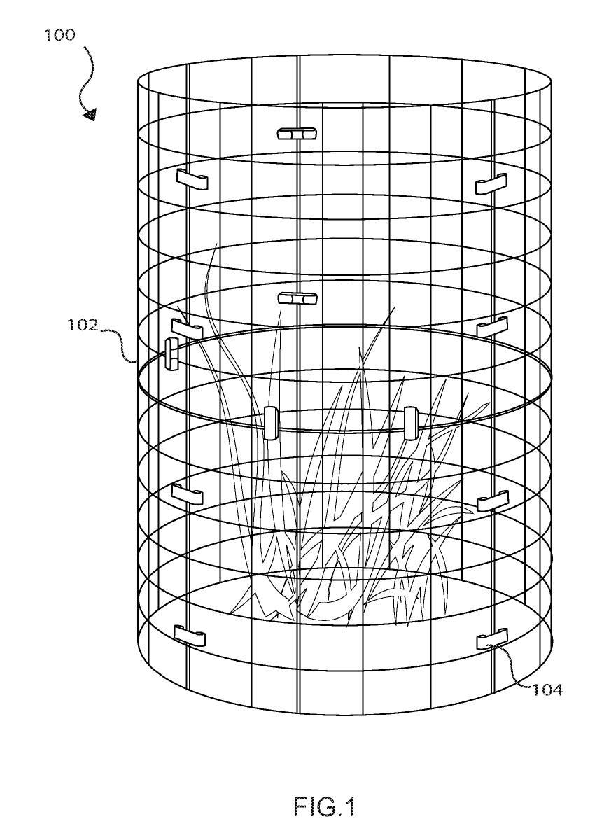

FIG. 1 illustrates the perspective view of the given invention of the plant safety device [100] which comprises: a plurality of flexible structures [102] coupled with a plurality of clamping units [104], wherein the plurality of clamping units [104] are formed with two open ends, curled over one another and the plurality of clamping units [104] are further designed to clip around the plurality of flexible structures [102] in order to configure the plurality of flexible structures [102] in whichever form desired to cover the plant. The plant safety device [100] herein is made up of a plurality of flexible structures [102] which are so flexible in nature that it is capable of bending easily without breaking and is also able to be easily modified to respond to altered circumstances. The material used for the manufacture of the plurality of flexible structure [102] is either one of plastic, thermoplastic, rigid PVC or the combination thereof. The plurality of flexible structures [102] are further coupled with the plurality of clamping units [104], wherein the plurality of clamping units [104] contain a clip or a flexible or spring-loaded device for holding an plurality of flexible structures [102], it is a kind of metal, plastic, thermoplastic or the combination thereof. The plant safety device [100] herein is prevents other plants from encroaching into the space reserved for the plant to be protected and thereby helping the plant to grow well within a specified condition. The plant safety device [100] is made of a plurality of flexible structures [102], constructed by a square grid. The plurality of flexible structures [102] is produced in 12″×14″ pieces. The plurality of flexible structure [102] pieces is attached to one another by the use of plurality of clamping units [104]. The plurality of clamping units [104] are formed with two open ends curled over, that are designed to clip around the plurality of flexible structures [102] so the at least one user is enabled to configure the plurality of flexible structures [102] in whichever form desired to cover the plant. Herein, the plurality of clapping units [104] is also enabled to configure the plurality of flexible structures [102] either horizontally or vertically around the circumference of the plant to be protected. The at least one user may also use the plurality of flexible structures [102] as ground cover to prevent unwanted plants from growing around the plant to be protected. The plurality of flexible structure [102] is secured to the ground by any shaped plurality of clamping unit [104] which go over the mesh and spike into the ground.

In the preferred embodiment of the given invention of the plant safety device [100] the at least one user willing to prevent the plants from encroaching into the space reserved for the plant to be protected and thereby helping the plant to grow well within a specified condition is provided with the plant safety device [100], wherein the plant safety device [100] comprises a plurality of flexible structures [102] coupled with a plurality of clamping units [104], wherein the plurality of clamping units [104] are formed with two open ends, curled over one another and the plurality of clamping units [104] are further designed to clip around the plurality of flexible structures [102] in order to configure the plurality of flexible structure [102] in whichever form desired to cover the plant. Herein, the at least one user is enabled to fix the plant safety device [100] around any plant he/her is willing to protect by applying some force over the plurality of flexible structure [102] which is enabled to be bent according to any desired shape and size of the at least one user and then hold the desired shape of the plurality of flexible structure [102] around the plant and against the ground with the help of the plurality of clamping units [104]. Herein, the plant safety device [100] is enabled to adjust according to any length and width of the plant as the at least one user is enabled to attach the plurality of flexible structure with one another either horizontally or vertically via a plurality of clamping units [104].

In another embodiment the plurality of clamping unit [104] is either removably or integrally coupled with the plurality of flexible structure [102].

While the invention has been described in detail with specific reference to preferred embodiments thereof, it is understood that variations and modifications thereof may be made without departing from the true spirit and scope of the invention.

What is claimed is:

1. A plant safety device comprises: plurality of flexible structures coupled with a plurality of clamping units, wherein the plurality of clamping units is designed to configure the plurality of flexible structure either horizontally or vertically around the circumference of the plant to be protected.

2. The plant safety device in claim 1; wherein the plurality of clamping unit is integrally coupled with the plurality of flexible structures.

3. The plant safety device in claim 1; wherein the plurality of clamping units is enabled to secure the plurality of flexible structures to the ground.

4. The plant safety device in claim 1; wherein the plurality of flexible structures is made up of either plastic, thermoplastic, rigid PVC or combination thereof.
